(19) United States
(12) Patent Application Publication
(10) Pub. No.: US 2018/0089546 A1
(43) Pub. Date: Mar. 29, 2018

(54) Building Element

(71) Applicant: Saint-Gobain Placo SAS, Suresnes (FR)

(72) Inventors: Nicholas Jones, Melton Mowbray (GB); Keith Humphrey, Coventry (GB); Jan Rideout, Rothley (GB)

(21) Appl. No.: 15/560,592

(22) PCT Filed: Mar. 23, 2016
(86) PCT No.: PCT/GB2016/050813

§ 371 Date: Sep. 22, 2017

(30) Foreign Application Priority Data
Mar. 26, 2015 (GB) 1505208.7

(51) Int. Cl. G06K 19/06; E04C 2/04

(52) U.S. Cl. CPC G06K 19/06196; E04C 2/043

(57) ABSTRACT

A building element (for example plasterboard) is described, and comprises a wirelessly or magnetically readable identifier. Since the identifier is wirelessly or magnetically readable, it is possible to determine the type of the plasterboard (or other building element) after installation, without damaging the plasterboard or any decoration applied to it.

### FIELD OF THE INVENTION

The present invention relates to building elements. Embodiments of the present invention relate to plasterboard.

### BACKGROUND TO THE INVENTION

As improved performance and functionality is being designed into plasterboard sheets, the question arises as to how people will know which walls have which performance or properties following installation.

Current state of the art to identify boards of specific performance has relied on either a coloured paper liner or in some cases, coloured gypsum core, however once the wall has been decorated it is difficult to ascertain the liner colour and the surface of the wall must be damaged (for example by drilling) in order to determine the colour of the core material.

Similar problems may arise with other building elements (e.g. studwork, metalwork or cavity insulation) which are effectively hidden following installation.

It would be desirable to have the capability to identify a specific plasterboard type (or type of other building element) following installation and decoration of the wall/ceiling from into which that building element was installed, without causing damage to plasterboard or other building element, or its decoration.

### SUMMARY OF THE INVENTION

According to the present invention there is provided a plasterboard building element comprising an identifier, wherein said identifier is wirelessly readable.

Preferably, said identifier comprises a radio frequency (RFID) transmitter. Additionally, it may be preferable that said identifier comprises a near field communication (NFC) transmitter.

Preferably, said identifier comprises a programmable chip and an antenna. Preferably, said programmable chip is pre-programmed or programmable with an identification code. It may also be preferable that said programmable chip is pre-programmed with at least one material characteristic of the building element. It may again be preferable that said identifier uniquely identifies the building element.

Preferably said building element comprises plasterboard, said plasterboard comprising a gypsum core sandwiched between a face layer and a backing layer.

Preferably, said identifier is affixed to an external surface of said building element. Alternatively, it may be preferable that said identifier is provided within the interior of said building element. It may be preferable to provide a building wherein said identifier is mounted at a predetermined position in said building element.

Preferably, said identifier is fixed to said backing layer. It may also be preferable to provide said identifier between said gypsum core and one of said backing layer and said face layer.

Preferably, said identifier is affixed to said building element using a fixing member, and said fixing member is permeable to water vapour. Preferably, said fixing member is an adhesive membrane.

Preferably information stored on said identifier can be read by a reader after said building element has been incorporated into a building. Preferably, said reader is a personal electronic device.

Also according to the invention, there is provided a method of preparing a plasterboard building element, comprising the steps of;

providing a first paper layer;

depositing a gypsum layer onto the first paper layer;

applying a second paper layer onto the deposited gypsum layer; and

including a wirelessly readable identifier.

Preferably, the step of including a wirelessly readable identifier comprises the further step of; providing said identifier between at least one paper layer and said gypsum layer.

Preferably, the step of providing said identifier between at least one paper layer and said gypsum layer comprises the further step of affixing said identifier to said paper layer using a fixing member which is permeable to water vapour.

According to a further aspect of the invention, there is provided a plasterboard building element comprising an identifier, wherein said identifier comprises a chipless antenna.

Preferably said antenna comprises printed metallic ink. Preferably said antenna extends continuously across at least one surface of said building element. Alternatively, it may be preferable that said antenna is located in a discrete area of said building element.

Preferably said building element comprises plasterboard, said plasterboard comprising a gypsum core sandwiched between a face layer and a backing layer. Preferably said antenna is located on an inner surface of at least one of said face layer and said backing layer, adjacent to said gypsum core.

Preferably said identifier uniquely identifies the building element. Preferably said identifier identifies at least one material characteristic of the building element. Preferably information stored on said identifier can be read by a reader.

Preferably information stored on said identifier can be read by a reader after said building element has been incorporated into a building. Preferably, information stored on said identifier can be read by a reader using radio waves emitted at frequencies between 2 and 10 GHz.

Also according to the invention, there is provided a method of preparing a plasterboard building element, comprising the steps of providing a face layer;

depositing a gypsum layer onto the face layer;

applying a backing layer onto the deposited gypsum layer; and

printing an antenna on at least one of the face layer and the backing layer.

Preferably the step of printing said antenna comprises; printing said antenna on an inner surface of at last one of the face layer and the backing layer, such that said antenna is adjacent to said gypsum layer.

Preferably, the step of printing said antenna comprises; printing said antenna in metallic ink.

According to a further aspect of the invention, there is provided a plasterboard building element comprising an identifier, wherein said identifier is magnetically readable.

Preferably said identifier comprises a pattern of magnetically detectable material.

Preferably said magnetically detectable material comprises magnetic paint. Preferably, said identifier is printed. Preferably, said magnetically detectable material comprises strips of metal.

Preferably said identifier extends continuously across at least one surface of said building element. Preferably said identifier is located in a discrete area of said building element. Preferably, said building element comprises plasterboard, said plasterboard comprising a gypsum core sandwiched between a face layer and a backing layer. Preferably, said identifier is located on an inner surface of at least one of said face layer and said backing layer, adjacent to said gypsum core.

Preferably said identifier uniquely identifies the building element. It may also be preferable for said identifier to identify at least one material characteristic of the building element. Preferably information stored on said identifier can be read by a reader. More preferably, information stored on said identifier can be read by a reader after said building element has been incorporated into a building.

Preferably, information stored on said identifier can be read by a metal detector.

Also according to the invention there is provided a method of preparing a plasterboard building element, comprising the steps of;

providing a first paper layer;

depositing a gypsum layer onto the first paper layer;

applying a second paper layer onto the deposited gypsum layer; and

including a magnetically readable identifier.

Preferably the step of including a magnetically readable identifier comprises the further step of providing said identifier between at least one paper layer and said gypsum layer.

According to a further aspect of the invention, there is provided a plasterboard building element comprising an identifier, wherein said identifier is thermally readable. Preferably said identifier comprises a pattern of thermally detectable material. Preferably said thermally detectable material comprises conductive members.

Preferably said thermally detectable material comprises conductive paint. Preferably, said thermally detectable material is printed. It may also be preferable that said identifier extends continuously across at least one surface of said building element. Alternatively, it may be preferable that said identifier is located in a discrete area of said building element.

Preferably, said building element comprises plasterboard, said plasterboard comprising a gypsum core sandwiched between a face layer and a backing layer. Preferably said identifier is located on an inner surface of at least one of said face layer and said backing layer, adjacent to said gypsum core.

Preferably said identifier uniquely identifies the building element. Preferably said identifier identifies at least one material characteristic of the building element. Preferably information stored on said identifier can be read by a reader.

Preferably information stored on said identifier can be read by a reader after said building element has been incorporated into a building. Preferably information stored on said identifier can be read by thermographic inspection.

Also according to the present invention, there is provided a method of preparing a plasterboard building element, comprising the steps of;

providing a first paper layer;

depositing a gypsum layer onto the first paper layer;

applying a second paper layer onto the deposited gypsum layer; and

including a thermally readable identifier.

Preferably the step of including a thermally readable identifier comprises the further step of providing said identifier between at least one paper layer and said gypsum layer.

According to another aspect of the present invention, there is provided a building element comprising a wirelessly or magnetically readable identifier. Since the identifier is wirelessly or magnetically readable, it is possible to determine the type and/or functionality of the plasterboard (or other building element) after installation, without damaging the plasterboard or any decoration applied to it.

The identifier may comprise an electronic tag. The electronic tag may comprise a chip which is preprogrammed or programmable with an identification code. The chip may be programmable with one or more of the type, capabilities, origin and ecotoxicity of the building element.

The identifier may comprise a radio frequency (RFID) transmitter. Alternatively, the identifier may comprise a pattern of magnetically detectable material. The magnetically detectable material may comprise magnetic paint or strips of metal.

In some cases the identifier may identify the type of the building element. However, in other cases the identifier may uniquely identify the building element.

The identifier may indicate one or more of the type, capabilities, origin or ecotoxicity of the building element.

Preferably, the building element is plasterboard, the plasterboard comprising a gypsum core sandwiched between a face layer and a backing layer. The identifier may comprise a layer of magnetically detectable material provided on the gypsum side of either the face layer or the backing layer.

Alternatively, the identifier may be fixed to an external surface of the plasterboard. This would typically take place once manufacture of the board is complete. Preferably in this case, the identifier is fixed to the backing layer so as not to risk being visible on the decorated face of the plasterboard once it is installed.

Alternatively, the identifier may be provided within the gypsum core.

Alternatively, the identifier may be provided between the gypsum core and one of the backing layer and the face layer.

Preferably, the identifier is mounted at a predetermined position in the plane of the plasterboard. This means that a user will have a good idea where to position a reader to detect the identifier following installation. Also, the position can be selected to minimise the risk that the identifier is present in an area of the plasterboard which is frequently “cut” away when the board is cut to size. It may for instance be desirable to locate the identifier near the centre of the plane of the plasterboard.

According to another aspect of the present invention, there is provided a wall and/or ceiling installation in which a wirelessly or magnetically readable identifier is invisibly embedded.

According to another aspect of the present invention, there is provided a reader configured to detect and read an identifier provided on or in a building element, and to display an indication of one or more of the type, capabilities and origin of the building element.

While in some cases the identifier may itself carry information about the building element to which it is fitted, in other cases the identifier may merely provide an identification code. In this case, the reader may be responsive to reading the identifier to look up one or more of the type, capabilities and origin of the building element in a database.

The reader may be a personal electronic device, for example a smartphone with a dedicated tag reading app.

Preferably, the building element is plasterboard, and the reader is operable to display instructions for fixing an object to the plasterboard and/or an indication of suitable fixings to use in fixing the object to the plasterboard.

Preferably, the building element is plasterboard, and the reader is operable to display instructions for the safe removal and/or disposal of the plasterboard.

In some cases, the reader may be operable to upload to a database in association with a tag identifier, information regarding an installation comprising the plasterboard. In this way, when a set of building elements are installed, the installer is able to program one or more identifiers within the installation with information about that installation, such as the name of the company which performed the installation, a job reference number, a date of installation and potentially information regarding any warranty provided by the installer.

According to another aspect of the present invention, there is provided a building element identification system comprising:

a plurality of wirelessly or magnetically readable identifiers each provided on or in a building element;

a database storing information about each of a plurality of types of building element; and

a reader configured to detect and read one of the identifiers, to obtain information about the building element in or on which the identifier is provided from the database, and to display the obtained information.

According to another aspect of the present invention, there is provided a method of preparing a plasterboard building element as defined in claim 1, the method comprising the steps of:

providing a first paper layer;

depositing a gypsum layer onto the first paper layer;

applying a second paper layer onto the deposited gypsum layer; and

applying an identifier on or in the plasterboard.

Preferably, the step of applying an identifier comprises one of:
applying the identifier between the first paper layer and the gypsum layer;
depositing the identifier into the gypsum layer; and
applying the identifier to the outside of the finished plasterboard.

While various magnetic and radio-based identification techniques are envisaged, other non-visual remotely detectable principles could also be used, such as thermal patterns or other thermal features, and the like. Accordingly, according to another aspect, there is provided a building element comprising a non-visual remotely detectable/readable identifier.

Where the building element is a board, this may be any type of board, for example a gypsum fibre board, a glass reinforced gypsum fibre board or a cement board. The building element could also be any other type of board or board-type structure, for example a pre-fabricated hollow wall element.

Where the building element is a board, this could be installed in walls, floors and ceilings (usually in the form of tiles in the latter case). Where the building element is stud/metalwork then this may be installed in walls, floors or ceilings. Where the building element is studwork, it may be made of metal or non-metal. The building element may also be a floor screed.

The building element may be a substantially rigid building element, such as board, studs and tracks, jointing materials (once set) and plasters (once set). The building element may be a structural element of a stud wall, ceiling or floor, for example boards, studs and tracks. The building element may be one of a board, stud, track, jointing material or plaster. The location of an identifier on or in a building element may depend on the nature of the building element. For example, for plasterboard the identifier may be provided on either external face of the board, or may be provided internally of the board. Similarly, for a stud frame, the identifier may be provided on any surface of the frame. For cavity insulation, the identifier may be provided either on an outer surface (fame) of the cavity insulation, or may be disposed/embedded within the body of the insulation.

### DETAILED DESCRIPTION

The invention will now be described by way of example with reference to the following Figures in which:

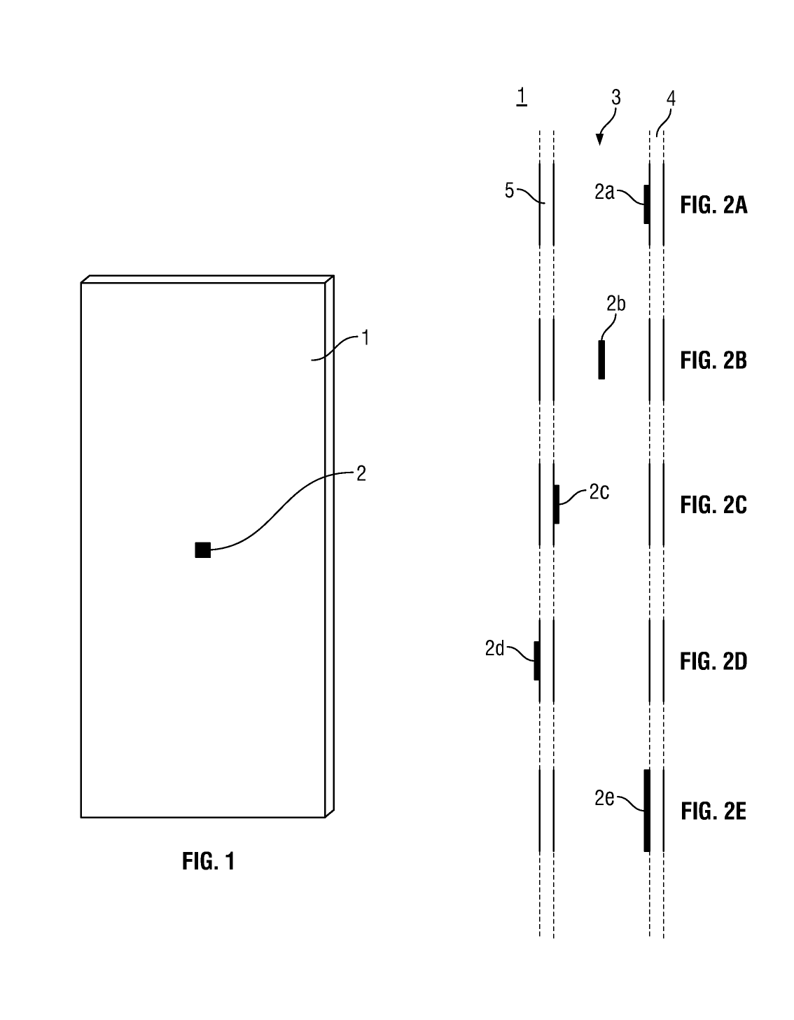

FIG. 1 schematically illustrates a plasterboard building element having a wirelessly or magnetically readable identifier;

FIG. 2 schematically illustrates a section through a plasterboard building element showing various positions within the layered structure of the plasterboard at which a wirelessly or magnetically readable identifier may be located;

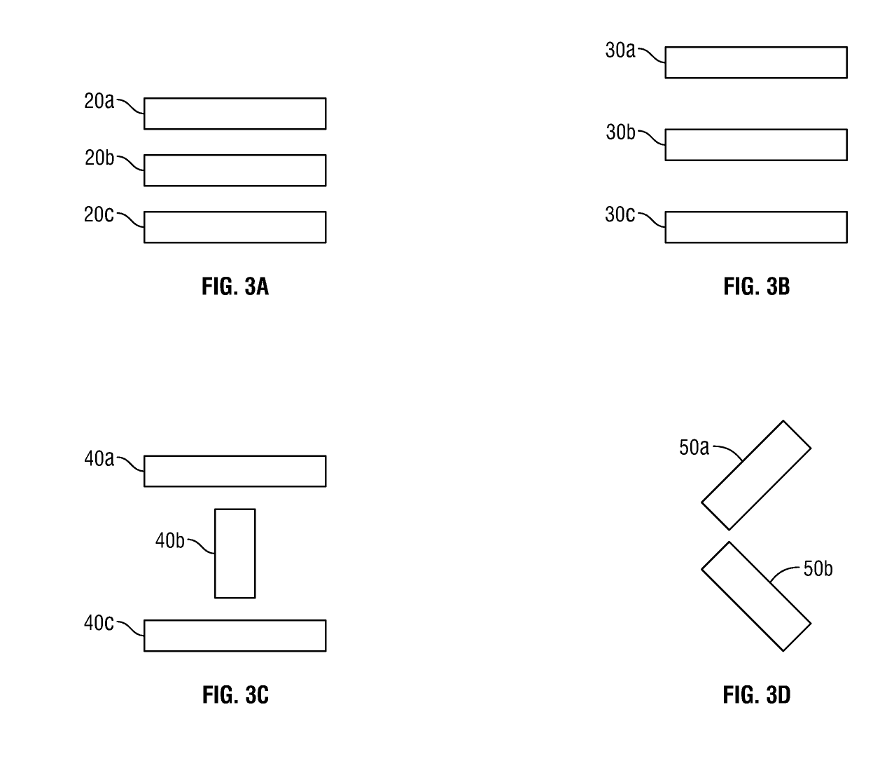

FIG. 3 schematically illustrates an example set of patterns of metallic or magnetic material which may be used as an identifier for the plasterboard;

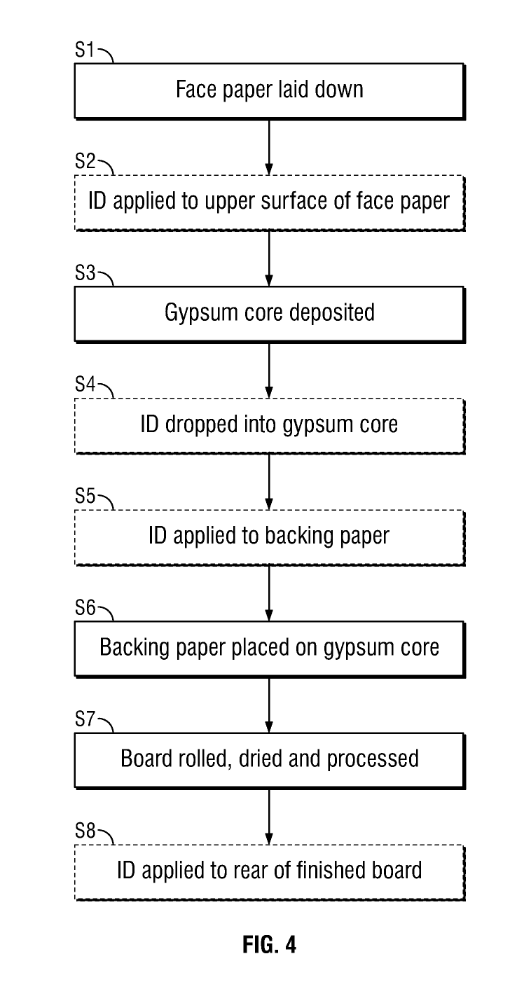

FIG. 4 is a schematic flow diagram indicating how a wirelessly or magnetically readable identifier may be applied to a plasterboard during the process of its manufacture; and

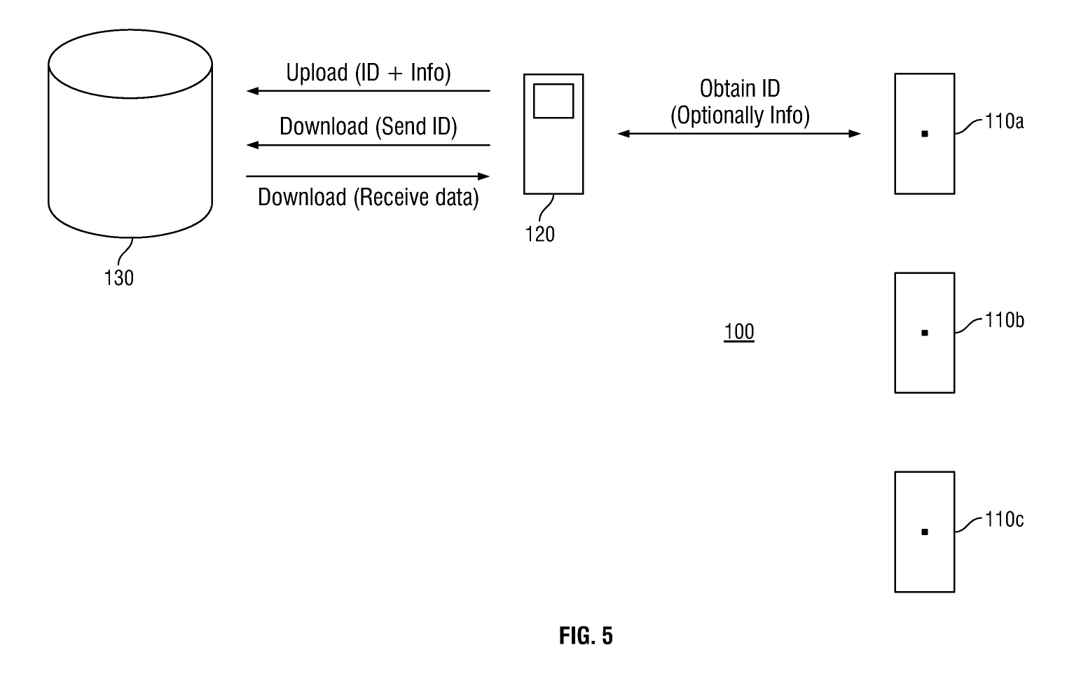

FIG. 5 schematically illustrates a board identification system.

Referring to FIG. 1, a plasterboard 1 as an example of a building element is shown to be provided with an identifier 2. In the present case the identifier 2 is positioned at or near the centre of the plasterboard, since this means that (a) the likelihood of the identifier 2 being preserved in a cut board is maximised, and (b) that in an uncut board the position of the identifier 2 is predictable in the finished installation. This is beneficial since by definition the identifier 2 cannot be observed visually, and reading devices may have a limited range, requiring the user to pass the reading device over large areas of wall or ceiling if the location of an identifier 2 cannot be readily predicted.

It will be appreciated that while embodiments of the present invention are described with reference to plasterboard, certain identification techniques and uses described herein could be applied to plasters, jointing compounds, jointing tape, metalwork, studs and other framing system structures, cavity insulation or other building elements. Two examples of this are that an identifier may be embedded into a jointing compound applied to smooth over joints between plasterboard sheets at the time of its application to the plasterboard. Further, identifiers may be provided on rolls of jointing tape for application to joints, or conventional jointing tape could be used to fix an identifier to an external surface of the plasterboard, while simultaneously sealing the identifier out of sight.

As the identifier remains out of sight and, most commonly, intact after the use of the building element in construction, the end user of the building can utilise the tag to gain information about the building element after the process of construction is complete. Such information may be useful when considering the weight bearing capacity of the construction element, which fixing should be used with the construction element, or how to dispose of the construction element in an environmentally effective manner.

To read the information contained on the identifier, the end user may use a personal electronic device. Such a device may take the form of a smartphone, most usually a smartphone capable of near field communication.

The identifier 2 may take several forms.

### Electronic Tag

In one example, the identifier 2 may be an electronic tag containing a pre-programmed or programmable chip and a radio frequency (RFID) transmitter, near-field communication (NFC) transmitter or other electronic article surveillance (EAS) wireless reading technology. For example, 58 kHz & 8.2 MHz EAS tags/labels may be adhered to the face paper on the gypsum side, the backing paper on either side or embedded within the gypsum core, as will be described below in FIG. 2. It has been found that these tags/labels are able to withstand the wet environment and drying process of plasterboard manufacture. Alternatively, such tags/labels may be adhered to the back of the plasterboard following the drying process (or even at the time of installation). This type of identifier may be detected using hand held EAS wands.

In another example, NFC/RFID tags/labels may first be programmed using a read/write app on a smartphone, and then either adhered to the face paper on the gypsum side, the backing paper on either side or embedded within the gypsum core. Again, it has been found that these tags/labels are able to withstand the wet environment and drying process of plasterboard manufacture. Alternatively such tags/labels may be adhered to the back of the plasterboard following the drying process (or even at the time of installation). This type of identifier may be detected using smartphones having an NFC/RFID reading and writing capability, and having a dedicated app running on them.

Additionally, NFC/RFID tags may be provided in a gypsum board, between the gypsum core and at least one of a backing layer and a face layer. Most commonly, the backing layer and the face layer are paper based, although plastics may also be used. To locate the NFC/RFID tags at the interface between the gypsum core and either the backing layer or the face layer, the tags are affixed to the interior surface of the backing layer or the face layer, before the layers are placed in contact with the gypsum slurry during plasterboard manufacture. When producing the tagged plasterboard in this way, the tags are selected such that they are not sensitive to the conditions experienced in the plasterboard during drying. In this embodiment of the invention, the tags are not sensitive to moisture, sensitive to water and do not react with the gypsum slurry. Additionally, the tags are resistant to high humidity and temperature, and may be resistant to distortions caused by mechanical disturbances in the gypsum slurry during the manufacturing process. Suitable tags are obtained by encapsulating the tag in a barrier coating, in this embodiment of the invention a plastic material.

During the production process, tags may be placed on either the backing layer or the face layer at known time intervals as the plasterboard is manufactured. The use of known time intervals, alongside the known rate of travel of the backing layer or face layer, will result in the tags being placed at known locations within the finished plasterboard. Most commonly, the tags are placed on the backing layer or the face layer close to the inlet of the extruder used during the manufacturing process, minimising the movement of the tag from its chosen position. Embodiments of the invention use adhesive to ensure the tag remains in the correct position in the manufactured board.

Placing an object such as a tag next to the baking layer or face layer of the plasterboard may prove problematic during the drying phase of the manufacturing process. The tag may inhibit the passage of water vapour through the drying plasterboard, resulting in blistering of the liner due to delamination. This delamination may further reduce the passage of heat and vapour through the board, resulting in uneven drying and areas of dampness. This uneven drying results in unsightly areas of the board, and can lead to further, more serious, manufacturing issues including wide scale delamination of the backing layer or facing layer, originating at the location of the tag.

To overcome the issues of blistering and delamination, it is advantageous to reduce the resistance of the tag to vapour transport, and/or create an intimate bond between the tag and the gypsum core of the plasterboard to resist the mechanical forces resulting from the tag's reduced permeability to water vapour. In this embodiment of the invention, this is achieved with the use of a permeable membrane to support the tag.

One method of providing a permeable membrane is to create micro perforations in the membrane supporting the tag, both allowing for the transport of water vapour through the membrane and allowing for a degree of keying between the membrane and the slurry. Alternatively, an open mesh, or an open fibrous tissue is used to support the tag. In either embodiment, a contact adhesive may then be used to attach the tag to the liner.

Chipless Tagging

Alongside NFC and RFID tagging, it is possible to use a chipless identifier to tag the building element. A chipless tag is a tag which comprises an antenna, but does not comprise or include a semiconductor chip in permanent communication with the antenna.

A chipless identifier can comprise a metallic ink, and may further be printed on to the backing layer or the face layer of a plasterboard. The printing process may be flexography, or, alternatively, is undertaken with an inkjet using dedicated metallic ink. The antenna forms a pattern which may extend across an entire surface of a building element, or be located in a discrete location on the building element.

Once incorporated into the building element, the antenna acts as an electromagnetic filter, the shape of the antenna influencing the reflection and transmission of electromagnetic waves. The information stored in the antenna is determined by the antenna shape. As such, the building element can be identified with a reader which emits electromagnetic radiation and detects these variations in the reflection and transmission of electromagnetic waves. The reader typically uses electromagnetic waves with a frequency of between 2 and 10 GHz, though a range of 2 to 4 GHz is also commonly used. Information from the antenna can be read from a range of up to 1 m, although reading distance below 0.3 m is preferred.

Thermal Identifier

Additionally, a thermal identifier can be used to tag the building element. Typically, a thermal identifier is formed of a pattern of thermally identifiable material, potentially in the form of a bar code or quick response (QR) code.

This pattern of thermally identifiable material can be formed of conductive members located within or on the surface of the building element, a conductive paint or a conductive material printed onto the building element. Conductive members may take the form of metallic bars or a metallic foil. In an embodiment of the invention, the conductive paint comprises metals or thermally conductive epoxies. The printing of conductive material on to the building element uses methods similar to those previously discussed in relation to chipless tagging, and elsewhere in this application.

In this embodiment of the invention, the pattern of thermally identifiable material may extend, or be positioned as discussed in relation to the other methods of tagging discussed in this application. In use, the thermal identifier is read with thermographic inspection or transient infrared thermography. During thermographic inspection, an energy source is used to produce a thermal contrast between the thermal identifier and the remained of the building element, and this thermal contrast imaged with the use of an IR camera. Here, flash lamps are used as the energy source.

Aluminium Strip/Magnetically Attracting Strip

In another example, aluminium (or other metallic) strips can be placed onto the face paper on the gypsum side. It has been found that these metallic strips can then be detected using a regular DIY metal detector. The pattern and/or spacing of the strips provides a way of identifying the board is and therefore indicating its functionality. As an alternative to aluminium foil, metallic paint can be used (in this case being painted in strips or other patterns), and a magnet can be used to detect the strips. It will be understood that any shape or patterning of metallic or magnetic material could be used—not just strips.

In the case of aluminium strips, these can be adhered to the plasterboard liner (face paper liner on the gypsum side), and then regular plasterboard production is conducted using the paper liner with adhered strips. Alternatively, a metallic paint consisting of magnetite and PVA or other binder material such as acrylic is prepared and then applied to the paper ahead of the regular plasterboard production process. The spacing of the strips of foil/paint provides a unique reference which can then be referenced to a particular board functionality. Similarly, magnetic ink may be printed onto the paper liner of the plasterboard—preferably prior to the paper liner being used to form the plasterboard. The magnetic ink may be set out in patterns in the same way as the painted strips/patterns.

### Magnetic Plaster Roller Coated Layer/Coating in Plasterboard

In another example, a thin 0.5 mm-3 mm roller coated layer of either 50:50 plaster and magnetite, or 75:25 plaster and magnetite or 87:13 plaster and magnetite is applied immediately beneath (i.e. to the gypsum facing side) of the front facing paper of plasterboard. Then, the remaining core material is deposited on top of the roller coated layer to achieve the bulk of the product. It has been found that magnets will adhere to all of the above compositions, and this adherence can be indicative of the presence of a certain board type or functionality. Alternatively, instead of the above plaster and magnetite layer, a very thin coating of magnetite in an adhesive carrier (<0.5 mm) may be applied to the gypsum side of the front facing paper. Again, it has been found that there is sufficient magnetic attraction to support lightweight strong magnets. Each of these solutions has been found to be preferably to a solution in which the magnetite is dispersed throughout the entire gypsum core as the level of magnetite required makes the product commercially unattractive and increases the weight of the board significantly creating a manual handling concern. In contrast, the concentration of the magnetite in a layer close to where it is needed (i.e. the face surface of the plasterboard) allows the functionality of magnetic plaster to be gained without prohibitively increasing the cost and weight of the product. It will be appreciated that magnets are readily available detection devices for most households. While this technique cannot be easily used to identify a wide range of different types of plasterboard, the presence versus absence of magnetic/metallic material is sufficient to distinguish between two key types—e.g. toxic versus non-toxic (important information for knowing how to remove and dispose of a board) or heavy mounting versus light mounting (important for a user to know whether the wall is able to support heavy items such as a television set, or only light items such as picture frames).

Referring to FIGS. 2A to 2E, a cross section through the plasterboard 1 of FIG. 1 is shown, with an identifier 2a to 2e being shown at various positions within the layered structure of the plasterboard 1. In particular, the plasterboard 1 is shown to comprise a gypsum core 3 sandwiched between a face (front) paper layer 4 and a backing paper layer 5. The face paper 4 is intended to provide the surface of the plasterboard 1 which is presented into a room, and which is to be decorated.

In FIG. 2A, the identifier 2a is shown to be provided between the face paper layer 4 and the gypsum core 3. This means that the identifier 2a is as close to the inside of the room as possible (making wireless or magnetic detection of the identifier 2a as easy as possible) while obscuring it behind the face paper 4. This location is suitable for the installation of electronic tags and metallic/magnetic strips or patterning.

In FIG. 2B, the identifier 2b is shown to be provided within the gypsum core 3 itself. This location is suitable for the installation of electronic tags, which it has been found are able to withstand the temperature and dampness conditions present in the gypsum mix. While the tag 2b is shown to be aligned with the plane of the board 1, in practice the tag 2b may adopt any orientation within the core 3, and still be readable.

In FIG. 2C, the identifier 2c is shown to be provided between the backing paper layer 5 and the gypsum core 3. This means that the identifier 2b is relatively protected from damage on or following installation (since damage is most likely to occur at the face paper layer 4 side of the board 1). This location is suitable for the installation of electronic tags.

In FIG. 2D, the identifier 2d is shown to be provided on the rear of the board 1. As a result, the identifier 2d can be applied following the main manufacturing process, simply by adhering it to the outside surface of the backing paper 5. In addition, the identifier 2d may be applied to the plasterboard 1 at the time of installation. This would have an advantage that only a single board (or at least a subset of the boards) within a particular wall and/or ceiling installation may be fitted, at the time of installation, with the identifier 2d. This assumes that all plasterboards within a given installation are likely to be of the same type.

In FIG. 2E, the identifier 2e is shown to be provided as a metallic or magnetic layer between the face paper layer 4 and the gypsum core 5. The presence or absence of the layer (detectable using a magnet for example) is indicative of the type or properties of the plasterboard.

Referring to FIG. 3, several patterns of metallic or magnetic strips are shown. In FIG. 3A, three parallel strips of metallic or magnetic material 20a, 20b, 20c are provided. The separation between the strips 20a, 20b, 20c is indicative of a particular board type or functionality. In FIG. 3B, three parallel strips of metallic or magnetic material 30a, 30b, 30c are provided. As can be seen by comparison with FIG. 3A, the strips 30a, 30b, 30c are further apart than the strips 20a, 20b, 20c, indicating that the pattern of strips in FIG. 3A and FIG. 3B relate to different board types/functionalities. In FIG. 3C, three strips 40a, 40b, 40c are provided, but in this case one of the strips—strip 40b is oriented at 90° to the strips 40a and 40c and extends generally from proximate the centre of the strip 40a to proximate the centre of the strip 40c. In this case it is the pattern of the strips (rather than their separation) which is indicative of the type or functionality of the board. In FIG. 3D, two strips 50a, 50b are provided, oriented at 90° to each other, one end of the strip 50a being proximate one end of the strip 50b. Again, it is the pattern of the strips (rather than their separation) which is indicative of the type or functionality of the board. It will further be appreciated that the size and/or shape of magnetic or metallic material could be used to indicate the type or functionality of the board.

Referring to FIG. 4, an example manufacturing process for a plasterboard having a wirelessly or magnetically readable identifier is described. Eight steps S1 to S8 are shown. The steps S1, S3, S6 and S7 describe a conventional process for the manufacture of plasterboard. The steps S2, S4, S5 and S8 define four possible steps which could be incorporated into the plasterboard manufacturing process to provide the plasterboard with wireless/magnetic identification. Only one of the steps S2, S4, S5 and S8 would in practice be utilised in a single manufacturing process, but these are shown together (in hatched boxes to indicate these features as being optional) in a single flow diagram in the interests of brevity.

At a step S1, a face paper layer is laid down. Optionally, at a step S2, an identifier is applied to the upper surface of the face paper. The identifier may be in the form of an electronic tag or pattern of magnetic or metallic material either placed on or adhered to the upper surface of the face paper, or a layer of magnetic material (combined plaster and magnetite or combined adhesive and magnetite, as described above) rolled on or otherwise applied to the upper surface of the face paper.

At a step S3, a gypsum core is deposited on the upper surface of the face paper (or onto the intervening magnetic/metallic layer if present). If an identifier had been applied at the step S2 then such identifier will thus be trapped between the gypsum core and the face paper.

Optionally, at a step S4, an identifier is dropped into the gypsum core. The identifier in this case may be an electronic tag. The electronic tag may be present in the gypsum slurry at the time it is deposited onto the face paper, or may be dropped in afterwards. The electronic tag may move around within the gypsum core until the core solidifies, but it has been found that the tag will still be readable irrespective of its eventual position within the core.

Optionally, at a step S5, an identifier is applied to a backing paper. The identifier in this case may be an electronic tag, fixed to the backing paper with an adhesive.

At a step S6, the backing paper is placed on the gypsum core, to sandwich the core between the face paper and the backing paper. If the identifier had been previously applied to the backing paper, then the identifier will thus be trapped between the backing paper and the core (if on the inside of the backing paper) or exposed at the rear of the plasterboard (if on the outside of the backing paper).

At a step S7, the board is rolled, dried and processed in the conventional way. It has been found that this conventional processing does not damage the identifiers applied as described in the steps S2, S4 and S5.

Optionally, an identifier may be applied to the rear of a finished board at the step S8. This may take place as part of the manufacturing process, or on site at the time of installation.

Referring to FIG. 5, a building element (plasterboard in this case) identification system 100 is shown. The identification system 100 comprises a plurality of wirelessly or magnetically readable identifiers each provided on or in a building element 110a, 110b, 110c. The system 100 further comprises a database 130 storing information about each of a plurality of types of plasterboard building element. Each type of plasterboard has an associated identifier. The system further comprises a reader configured to detect and read one of the identifiers on the building elements 110a, 110b, 110c, to obtain information about the building element in or on which the identifier is provided from the database, and to display the obtained information on a display screen of the reader. It will be appreciated that this system enables the identifiers applied to the building elements to be “dumb”—merely identifying the plasterboard type, while the database 130 can be programmed and kept updated with the most recent information about each board type. This also means that the identifier can be as simple and inexpensive as possible.

In FIG. 5, the reader 120 is able to access the identifier by wireless (e.g. radio or microwave) or magnetic means. It may be possible for the reader 120 to write an identification code to the identifier, for example at the time of installation to either simply initialise the identifier, or as part of a process of recording details of the installation to the database 130. In these cases, the identifier and information will be uploaded to the database 130 from the reader 120. In other cases the reader 120 may only be able to read data from the identifier and/or database 130. Either way, to obtain information from the database 130, the reader first determines the identity of the board from the identifier on the board 110a, 110b, 110c, for example by reading an identification code, and then uses the identification code to access the appropriate entry in the database 130. In particular, the database 130 is responsive to the identification code to provide the reader with information relating to the appropriate plasterboard type. In some cases, the identification code may be unique to a particular sheet of plasterboard. In other cases the identification code may be unique to a particular batch of plasterboard sheets. In still other cases the identification code may be unique to a particular type of plasterboard. In still other cases the identification code may be unique to a particular installation (e.g. a construction site, building, contract etc.). The database may store various information in relation to a particular sheet, batch or type of plasterboard, for example:

Type—fixing strength, fire resistance, ecotoxicity, soundproofing capability, plus user instructions for mounting items to it, decorating, removal and disposal.

Batch or individual sheet—date and location of manufacture, warranty details.

Installation—installing company, notes regarding installation, notes regarding warranty.

While the benefits of a database supported identification system will be apparent from the above, it will however be understood that it may be acceptable for all information regarding the plasterboard to be stored in an electronic tag on the plasterboard, which would remove the need for a dedicated database. Optionally, some or all of the information regarding the plasterboard may be stored (for example by a reader) at the time of installation. Generally, any information which could be provided in the database could also be provided directly on an chip based tag, albeit without the capability to keep the information up to date. It will also be understood that it may be acceptable for all information regarding the plasterboard to be looked up manually by a user, once the identifier has been used to indicate the type of the plasterboard.

It will be appreciated that a user may utilise the information from the database (or the electronic tag itself) in a variety of ways. For example, an end user wishing to know whether they can mount a heavy television to a particular wall can simply use a reader to scan the wall for the identifier, and use the identifier to determine whether the plasterboard is of a type which can support the weight of the television. The reader may also display to the user appropriate fixings (potentially with a link to an informational or purchasing website for those fixings) for mounting heavy objects to the wall.

As another example, the performance of a building element may only be underwritten when the overall system has been built entirely from specific components, for example components of a specific standard, or from a particular supplier. However, some such warranties may last for many years following installation, following which records regarding that installation may no longer be accessible. The use of identifiers within the building elements makes it possible to confirm that all building elements are of an appropriate type or from a permitted supplier.

It will further be appreciated that the NFC/RFID technology could link to other sources of information regarding the product—for example loading data, best ways to decorate, user blogs and so on.

Other methods of applying an identifier to a plasterboard or other building element are also envisaged. For example, the paper liner of a plasterboard could have a pattern of metallic (conductive) ink printed on it. The pattern could be a continuous pattern extending across the surface of the paper liner, or could be a discrete area of the paper liner to which the metallic ink has been applied. The pattern may be printed onto the liner before the liner is used to form the plasterboard, or could instead be printed onto the plasterboard following its manufacture. The pattern acts as an electromagnetic filter, differences in the shape of the pattern changing the quantity of electromagnetic waves which are reflected and or transmitted. For board identification, the basic idea is to print a different drawing/pattern for each type of board. Then, when a suitable reader (such as a mobile phone) is moved in the vicinity of the pattern/drawing and used to emit electromagnetic radiation, by simply measuring the quantity of signal reflected, it is possible to identify the board, and thus its origin and/or characteristics.

1-34. (canceled)

35. A plasterboard building element comprising an identifier, wherein said identifier is magnetically readable.

36. A plasterboard building element according to claim 35, wherein said identifier comprises a pattern of magnetically detectable material.

37. A plasterboard building element according to claim 35, wherein said magnetically detectable material comprises magnetic paint.

38. A plasterboard building element according to claim 35, wherein said identifier is printed.

39. A plasterboard building element according to claim 35, wherein said magnetically detectable material comprises strips of metal.

40. A plasterboard building element according to claim 35, wherein said identifier extends continuously across at least one surface of said building element.

41. A plasterboard building element according to claim 35, wherein said identifier is located in a discrete area of said building element.

42. A plasterboard building element according to claim 35, wherein said building element comprises plasterboard, said plasterboard comprising a gypsum core sandwiched between a face layer and a backing layer.

43. A plasterboard building element according to claim 42, wherein said identifier is located on an inner surface of at least one of said face layer and said backing layer, adjacent to said gypsum core.

44. A plasterboard building element according to claim 35, wherein said identifier uniquely identifies the building element.

45. A plasterboard building element according to claim 35, wherein said identifier identifies at least one material characteristic of the building element.

46. A plasterboard building element according to claim 35, wherein information stored on said identifier can be read by a reader.

47. (canceled)

48. A method of preparing a plasterboard building element, comprising the steps of;
providing a first paper layer;
depositing a gypsum layer onto the first paper layer;
applying a second paper layer onto the deposited gypsum layer; and
including a magnetically readable identifier.

49. A method of preparing a plasterboard building element according to claim 48, wherein the step of including a magnetically readable identifier comprises the further step of;
providing said identifier between at least one paper layer and said gypsum layer.

50-97. (canceled)
